(19) United States
(12) Patent Application Publication
(10) Pub. No.: US 2026/0113248 A1
(43) Pub. Date: Apr. 23, 2026

(54) ESTIMATING A CARBON FOOTPRINT OF AN INCOMING WORKLOAD TO BE HOSTED ON A CLOUD DATA CENTER

(71) Applicant: International Business Machines Corporation, Armonk, NY (US)

(72) Inventors: Umamaheswari Devi, Bangalore (IN); Aanchal Goyal, Gurugram (IN); Kalyan Kanti Dasgupta, Bangalore (IN); Tamar Eilam, New York, NY (US)

(21) Appl. No.: 18/919,134

(22) Filed: Oct. 17, 2024

(51) Int. Cl. H04L 41/147; H04L 41/16; H04L 67/10

(52) U.S. Cl. CPC H04L 41/147; H04L 41/16; H04L 67/10

(57) ABSTRACT

A computer-implemented method, system, and computer program product for estimating a carbon footprint of an incoming workload to be hosted on a cloud data center. Trained first and second machine learning models are used in combination to estimate the energy consumption for the incoming workload to be hosted on the cloud data center based on the active energy consumption and the idle energy consumption predicted by the trained first and second machine learning models. Upon estimating the energy consumption for the incoming workload, the carbon footprint for the incoming workload is estimated based on the estimated energy consumption for the incoming workload as well as the power usage effectiveness of the incoming workload and the carbon intensity of the incoming workload. In this manner, carbon emissions attributable to workloads to be deployed to a data center (e.g., cloud data center) prior to deployment may be estimated.

### TECHNICAL FIELD

The present disclosure relates generally to energy usage of cloud data centers, and more particularly to estimating a carbon footprint of an incoming workload to be hosted on a cloud data center.

### BACKGROUND

A data center is a physical location that stores computing machines and their related hardware equipment. It contains the computing infrastructure that information technology (IT) systems require, such as servers, data storage drives, and network equipment. It is the physical facility that stores company's digital data.

### SUMMARY

In one embodiment of the present disclosure, a computer-implemented method for comprises training a first machine learning model to predict an active energy consumption and an idle energy consumption for workloads hosted on the cloud data center based on features of characteristics of clusters of servers and features of characteristics of workloads. The method further comprises training a second machine learning model to predict the active energy consumption and the idle energy consumption for workloads hosted on the cloud data center based on predicted metrics for the clusters of servers and for the workloads. The method additionally comprises receiving a workload to be hosted on the cloud data center. Furthermore, the method comprises predicting the active energy consumption and the idle energy consumption for the workload using the first trained machine learning model based on features of the characteristics of the workload and features of the characteristics of a cluster of servers the workload is to be processed. Additionally, the method comprises predicting the active energy consumption and the idle energy consumption for the workload using the trained second machine learning model using predicted metrics for the cluster of servers as well as for the workload. In addition, the method comprises estimating an energy consumption for the workload based on the active energy consumption and the idle energy consumption for the workload predicted by the trained first machine learning model and the trained second machine learning model. The method further comprises estimating a carbon footprint for the workload based on the estimated energy consumption for the workload, a power usage effectiveness of the workload and a carbon intensity of the workload.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 illustrates the components of the cloud data center in accordance with an embodiment of the present disclosure;

FIG. 3 is a diagram of the software components used by the carbon footprint estimator for estimating a carbon footprint of an incoming workload to be hosted on the cloud data center in accordance with an embodiment of the present disclosure;

FIG. 4 illustrates an embodiment of the present disclosure of the hardware configuration of the carbon footprint estimator which is representative of a hardware environment for practicing the present disclosure;

FIG. 5 is a flowchart of a method for training machine learning models to predict an active energy consumption and an idle energy consumption for workloads hosted on the cloud data center in accordance with an embodiment of the present disclosure; and

FIGS. 6A-6C are a flowchart of a method for estimating a carbon footprint of an incoming workload to be hosted on a cloud data center in accordance with an embodiment of the present disclosure

### DETAILED DESCRIPTION

As stated above, a data center is a physical location that stores computing machines and their related hardware equipment. It contains the computing infrastructure that information technology (IT) systems require, such as servers, data storage drives, and network equipment. It is the physical facility that stores company's digital data.

Cloud data centers (also called cloud computing data centers) house IT infrastructure resources for shared use by multiple customers—from scores to millions of customers—via an Internet connection.

Currently, data centers, including cloud data centers, consume 1-2% of the total worldwide generated electricity. It is projected that such data centers will consume 8-20% of the total worldwide generated electricity by 2030 due to rapidly increasing application demand, emerging high-energy artificial intelligence workloads, and the flattening of data center power usage effectiveness.

In recent years, there has been an increased attention on climate change, which refers to long-terms shifts in temperatures and weather patterns. As a result, there has been a desire to reduce carbon emissions which may be one of the causes of climate change, such as carbon emissions from processing workloads by a cloud data center. That is, there has been a desire to reduce the carbon footprint from processing workloads. A “carbon footprint” refers to the total amount of greenhouse gases, primarily carbon dioxide, emitted by an organization or activity, essentially measuring the contribution to climate change caused by that entity. By reducing one's carbon footprint, the effects of climate change are hoped to be mitigated.

Consequently, there is a need to quantify the amount of carbon emissions that result from processing workloads, such as at a cloud data center.

Currently, efforts in quantifying the amount of carbon emissions have been focused on workloads that have already been deployed and running on the cloud data center. However, entities may desire to know the amount of carbon emissions that result from a workload to be deployed to a cloud data center prior to such deployment so that the entities can make an informed decision regarding having the cloud data center host the workload. For example, the entity may decide to have the workload be hosted on-premise or be hosted by a different cloud data center which produces a lesser amount of carbon emissions from processing such a workload thereby improving the efficiency of energy utilized for processing workloads.

Unfortunately, there is not currently a means for estimating the carbon emissions attributable to workloads to be deployed to a data center (e.g., cloud data center) prior to deployment.

The embodiments of the present disclosure provide a means for estimating a carbon footprint of an incoming workload to be hosted on a cloud data center. In one embodiment, a first machine learning model is trained to predict an active energy consumption and an idle energy consumption for the workloads hosted on the cloud data center based on the features of the characteristics of the clusters of servers of the cloud data center and the features of the characteristics of the workloads processed by the cloud data center. An active energy consumption, as used herein, refers to the energy being consumed (e.g., energy consumed by the data center's computing resources, such as servers, storage, and network) due to the execution of the workload. A workload, as used herein, refers to the tasks, processes, or data transactions to be performed by the cloud data center. An idle energy consumption, as used herein, refers to the energy being consumed by the cloud data center's computing resources (e.g., servers, storage, network) that is independent of the workload and corresponds to the energy required to keep the equipment (e.g., information technology equipment) in active idle state. A cluster of servers, as used herein, refers to a group of servers working simultaneously, such as under a single IP address, that are located within the cloud data center to process a particular incoming workload from a tenant. In one embodiment, a second machine learning model is trained to predict an active energy consumption and an idle energy consumption for the workloads hosted on the cloud data center based on the predicted metrics for the clusters of servers of the cloud data center and the predicted metrics for the workloads processed by the cloud data center. In one embodiment, such predicted metrics are generated based on time series data.

Upon training such machine learning models, such machine learning models are used in combination to estimate the energy consumption for an incoming workload to be hosted on the cloud data center based on the active energy consumption and the idle energy consumption predicted by the trained first and second machine learning models. For example, the first trained machine learning model predicts the active energy consumption and the idle energy consumption for the workload based on the features of the characteristics of the workload and the features of the characteristics of the cluster of servers to process the workload. The second trained machine learning model predicts the active energy consumption and the idle energy consumption for the workload using the predicted metrics for the cluster of servers to process the workload and the predicted metrics for the workload. In one embodiment, such predicted metrics for the cluster of servers as well as for the workload are based on the time series data generated for the cluster of servers as well as the workload. The time series data, as used herein, refers to data that is recorded over consistent intervals of time. For example, such time series data may be generated from aggregated data recorded over consistent intervals of time, such as server resource utilization, energy consumption metrics, workload aggregate size, workload utilization, etc.

Upon estimating the energy consumption for the workload, the carbon footprint for the workload is estimated based on the estimated energy consumption for the workload as well as the power usage effectiveness of the workload and the carbon intensity of the workload. The power usage effectiveness of the workload is a metric that measures how efficient a cloud data center is at using energy in connection with the workload. In one embodiment, the power usage effectiveness is calculated using historical time series data (measurements or events that are tracked), such as the total amount of energy a cloud data center used divided by the amount of energy used by its IT equipment involving the processing of the workload by the cloud data center. The carbon intensity of the workload refers to how many grams of carbon dioxide (CO₂) are released to produce a kilowatt hour (kWh) of electricity. In one embodiment, the carbon intensity of the workload is calculated using historical time series data (measurements or events that are tracked), such as the grams of carbon dioxide (CO₂) released to produce a kilowatt hour (kWh) of electricity involving the processing of the workload by the cloud data center.

In this manner, carbon emissions attributable to workloads to be deployed to a data center (e.g., cloud data center) prior to deployment may be estimated thereby enabling entities to make informed decisions regarding hosting the workload. For example, the entity may decide to have the workload be hosted by a particular cloud data center which produces a lesser amount of carbon emissions from processing such a workload versus another cloud data center thereby improving energy efficiency for processing workloads. A further discussion regarding these and other features is provided below.

In some embodiments of the present disclosure, the present disclosure comprises a computer-implemented method, system, and computer program product for estimating a carbon footprint of an incoming workload to be hosted on a cloud data center. In one embodiment of the present disclosure, a first machine learning model is trained to predict an active energy consumption and an idle energy consumption for workloads hosted on the cloud data center based on the features of the characteristics of the clusters of servers of the cloud data center and the features of the characteristics of the workloads processed by the cloud data center. Furthermore, a second machine learning model is trained to predict an active energy consumption and an idle energy consumption for workloads hosted on the cloud data center based on the predicted metrics for the clusters of servers of the cloud data center and the predicted metrics for the workloads processed by the cloud data center. Upon training such machine learning models, such machine learning models are used in combination to estimate the energy consumption for an incoming workload to be hosted on the cloud data center based on the active energy consumption and the idle energy consumption predicted by the trained first and second machine learning models. Upon estimating the energy consumption for the workload, the carbon footprint for the workload is estimated based on the estimated energy consumption for the workload as well as the power usage effectiveness of the workload and the carbon intensity of the workload. In this manner, carbon emissions attributable to workloads to be deployed to a data center (e.g., cloud data center) prior to deployment may be estimated thereby enabling entities to make informed decisions regarding hosting the workload, including utilizing more energy efficient means for processing the workload. For example, the workload may be hosted by a particular cloud data center which produces a lesser amount of carbon emissions from processing such a workload in comparison to other cloud data centers.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

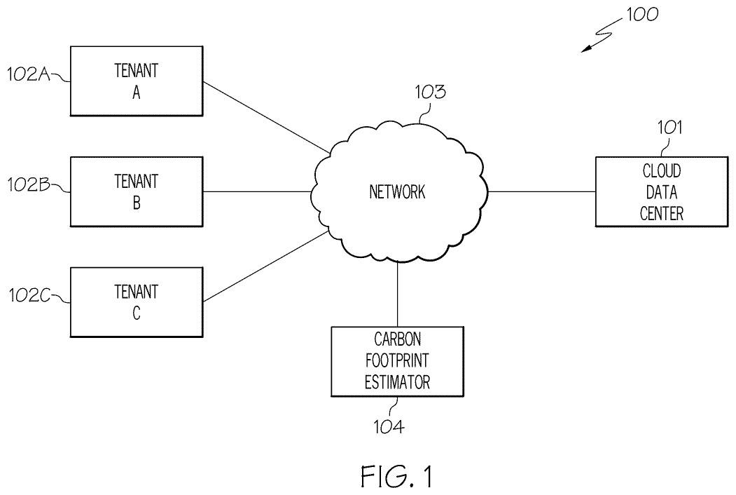

Referring now to the Figures in detail, FIG. 1 illustrates an embodiment of the present disclosure of a communication system 100 for practicing the principles of the present disclosure. Communication system 100 includes a cloud data center 101 connected to tenants 102A-102C via a network 103. Tenants 102A-102C may collectively or individually be referred to as tenants 102 or tenant 102, respectively.

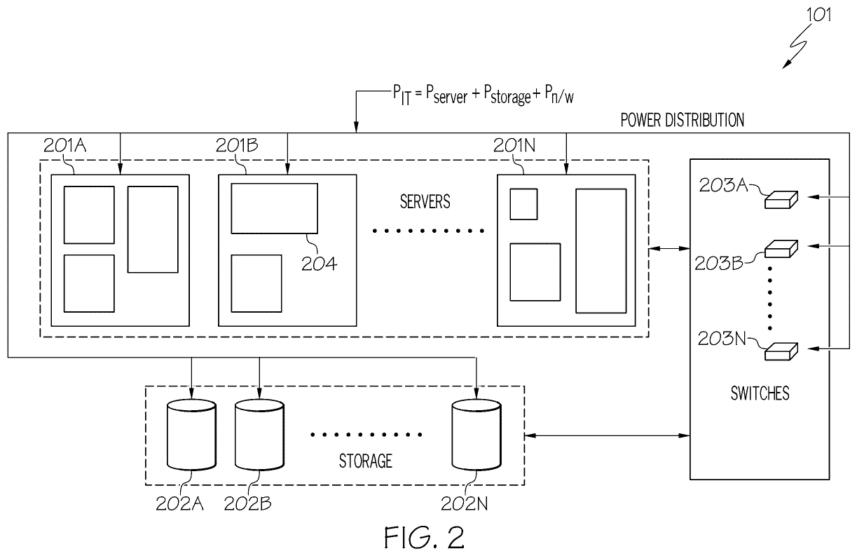

Cloud data center 101, as used herein, houses information technology (IT) infrastructure resources for shared use by multiple customers, such as tenants 102, via an Internet connection. In one embodiment, cloud data center 101 includes various components that use power (power is the rate at which energy is transferred or use), such as servers, storage devices, and switches. A description of the components of cloud data center 101 is provided below in connection with FIG. 2.

Tenant 102, as used herein, is a group of users who share a common access with specific privileges, such as to a software instance. A “multi-tenant” cloud data center, as used herein, refers to a cloud data center, such as cloud data center 101, that hosts workloads issued from multiple tenants 102, such as tenants 102A-102C. That is, in one embodiment, cloud data center 101 corresponds to a multi-tenant cloud data center utilized by multiple tenants 102, such as via network 103.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

Furthermore, communication system 100 includes a carbon footprint estimator 104 connected to tenants 102 and cloud data center 101 via network 103. In one embodiment, carbon footprint estimator 104 is configured to estimate a carbon footprint of an incoming workload to be hosted on cloud data center 101. A workload, as used herein, refers to the tasks, processes, or data transactions to be performed by cloud data center 101.

In one embodiment, carbon footprint estimator 104 trains a first and a second machine learning model to predict an active energy consumption and an idle energy consumption for the workloads hosted on cloud data center 101. In one embodiment, carbon footprint estimator 104 trains the first machine learning model to predict an active energy consumption and an idle energy consumption for the workloads hosted on cloud data center 101 based on the features of the characteristics of the clusters of servers of cloud data center 101 and the features of the characteristics of the workloads processed by cloud data center 101. In one embodiment, carbon footprint estimator 104 trains the second machine learning model to predict an active energy consumption and an idle energy consumption for the workloads hosted on cloud data center 101 based on the predicted metrics for the clusters of servers of cloud data center 101 and the precited metrics for the workloads processed by cloud data center 101.

Upon training such machine learning models, such machine learning models are used in combination by carbon footprint estimator 104 to estimate the energy consumption for an incoming workload to be hosted on cloud data center 101 based on the active energy consumption and the idle energy consumption predicted by the trained first and second machine learning models. For example, carbon footprint estimator 104 predicts the active energy consumption and the idle energy consumption for the workload using the trained first machine learning model based on the features of the characteristics of the workload and the features of the characteristics of the cluster of servers selected to process the workload. Furthermore, carbon footprint estimator 104 predicts the active energy consumption and the idle energy consumption for the workload using the trained second machine learning model using the predicted metrics for the cluster of servers of cloud data center 101 selected to process the workload and the predicted metrics for the workload. The energy consumption for the incoming workload to be hosted on cloud data center 101 is then estimated based on the predictions of the trained first and second machine learning models.

Upon estimating the energy consumption for the workload, carbon footprint estimator 104 estimates the carbon footprint for the workload based on the estimated energy consumption for the workload as well as the power usage effectiveness of the workload and the carbon intensity of the workload. The power usage effectiveness of the workload is a metric that measures how efficient a cloud data center (e.g., cloud data center 101) is at using energy in connection with the workload. In one embodiment, the power usage effectiveness is calculated using historical time series data (measurements or events that are tracked), such as the total amount of energy cloud data center 101 used divided by the amount of energy used by its IT equipment involving the processing of the workload by cloud data center 101. The carbon intensity of the workload refers to how many grams of carbon dioxide (CO₂) are released to produce a kilowatt hour (kWh) of electricity. In one embodiment, the carbon intensity of the workload is calculated using historical time series data (measurements or events that are tracked), such as the grams of carbon dioxide (CO₂) released to produce a kilowatt hour (kWh) of electricity involving the processing of the workload by cloud data center 101. In this manner, carbon emissions attributable to workloads to be deployed to a data center (e.g., cloud data center 101) prior to deployment may be estimated thereby enabling entities, such as tenants 102, to make informed decisions regarding hosting the workload. For example, the entity, such as tenant 102, may decide to have the workload hosted by a particular cloud data center 101 which produces a lesser amount of carbon emissions from processing such a workload versus another cloud data center 101 thereby improving energy efficiency for processing workloads.

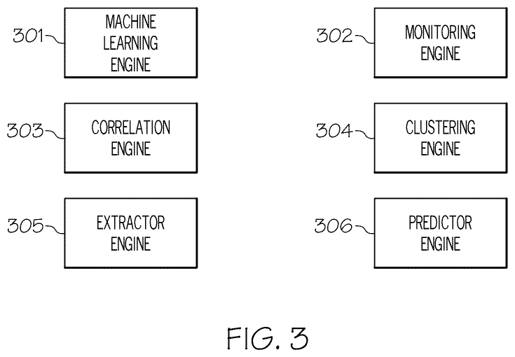

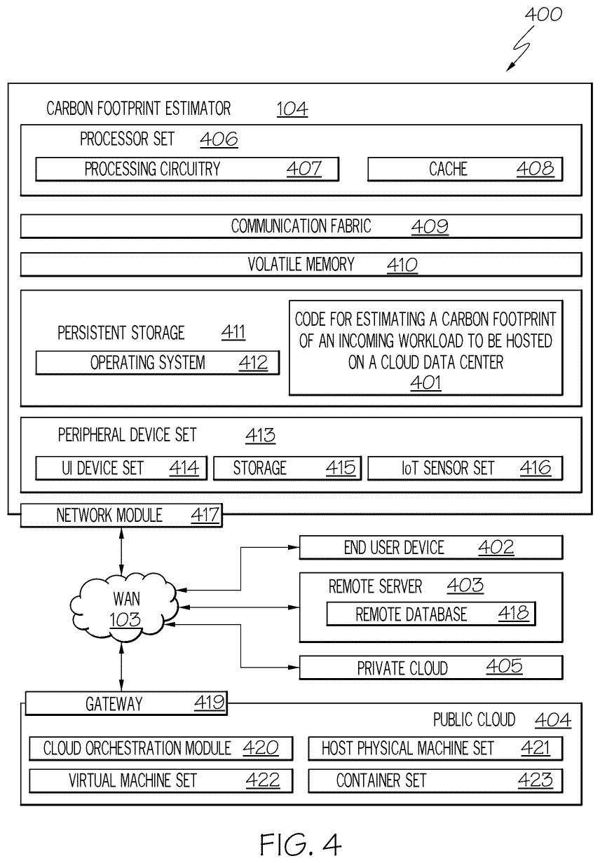

A description of the software components of carbon footprint estimator 104 used for estimating a carbon footprint of an incoming workload to be hosted on cloud data center 101 is provided below in connection with FIG. 3. A description of the hardware configuration of carbon footprint estimator 104 is provided further below in connection with FIG. 4.

System 100 is not to be limited in scope to any one particular network architecture. System 100 may include any number of cloud data centers 101, tenants 102, networks 103, and carbon footprint estimators 104.

Referring now to FIG. 2, FIG. 2 illustrates the components of cloud data center 101 (FIG. 1) in accordance with an embodiment of the present disclosure.

As shown in FIG. 2, in conjunction with FIG. 1, cloud data center 101 includes servers 201A-201N, storage devices 202A-202N, and switches 203A-203N, where N is a positive integer number. Servers 201A-201N may collectively or individually be referred to as servers 201 or server 201, respectively. Storage devices 202A-202N may collectively or individually be referred to as storage devices 202 or storage device 202, respectively. Switches 203A-203N may collectively or individually be referred to as switches 203 or switch 203, respectively.

Server 201 in cloud data center 101 is a computer that delivers applications, services, and data to end-user devices, such as tenants 102. Storage devices 202 include devices, such as hard disk drives, solid-state drives, tape drives, hybrid flash arrays, all-flash arrays, storage area networks, network attached storage devices, etc. to store data. Furthermore, such storage devices 202 may include the software and processes that manage and monitor data storage. Switches 203 connect servers 201, storage devices 202, and other network devices so that they can share data and communicate with each other.

In one embodiment, as discussed further below, such servers 201 may be clustered by carbon footprint estimator 104 so as to perform selective disaggregation. Such selective disaggregation is utilized so as to focus on the particular servers 201 that are utilized for processing the workload issued by tenant 102. Clustering, as used herein, refers to grouping servers 201 in such a way that such servers 201 are utilized to process a particular incoming workload from tenant 102. A cluster of servers, as used herein, refers to a group of servers 201 working simultaneously, such as under a single IP address, to process a particular incoming workload from tenant 102. In one embodiment, carbon footprint estimator 104 clusters servers 201 based on a variety of features, such as hardware characteristics, workload type, load pattern, etc. A further discussion regarding clustering servers 201 is provided further below.

In one embodiment, servers 201 host virtual machines (VMs) 204, which are used to process the workloads issued by tenants 102. A VM 204, as used herein, is a software-based computer that can run programs and operating systems, similar to a physical computer. VMs 204 are often used as a separate computing environment, such as to run a different operating system or to function as the tenant's entire computer experience.

In one embodiment, the power distribution of the information technology (IT) infrastructure resources (P_{IT}) of cloud data center 101 is equal to the power of servers 201 (Pₛₑᵣᵥₑᵣ), plus the power of storage devices 202 (P_{storage}) plus the power of the network devices, such as switches 203 (P_{n/w}). In one embodiment, the power of servers 201 (Pₛₑᵣᵥₑᵣ) is a function of the central processing unit (CPU) utilization, memory activity, and input/output activity (disk accesses) on servers 201, which is approximately equal to the function of the CPU utilization.

In one embodiment, the carbon footprint of an incoming workload to be hosted on cloud data center 101 from tenant 102 with energy consumption E(t) over time t is E(t)×PUE(t)×C_{I}(t), where PUE corresponds to the power usage effectiveness and C_{I} corresponds to carbon intensity.

The power usage effectiveness of the incoming workload is a metric that measures how efficient a cloud data center is at using energy in connection with the workload. In one embodiment, the power usage effectiveness is calculated using historical time series data (measurements or events that are tracked), such as the total amount of energy cloud data center 101 used divided by the amount of energy used by its IT equipment (e.g., servers 201, storage devices 202, and switches 203) involving the processing of the workload by cloud data center 101. The carbon intensity of the workload refers to how many grams of carbon dioxide (CO₂) are released to produce a kilowatt hour (kWh) of electricity. In one embodiment, the carbon intensity of the workload is calculated using historical time series data (measurements or events that are tracked), such as the grams of carbon dioxide (CO₂) released to produce a kilowatt hour (kWh) of electricity involving the processing of the workload by cloud data center 101.

The following discusses embodiments of carbon footprint estimator 104 estimating the energy consumption of the incoming workload issued from tenant 102 thereby estimating the carbon footprint of an incoming workload issued from tenant 102 to be hosted on cloud data center 101.

As discussed above, a discussion regarding the software components used by carbon footprint estimator 104 used for estimating a carbon footprint of an incoming workload to be hosted on cloud data center 101 is provided below in connection with FIG. 3.

FIG. 3 is a diagram of the software components used by carbon footprint estimator 104 for estimating a carbon footprint of an incoming workload to be hosted on cloud data center 101 in accordance with an embodiment of the present disclosure.

Referring to FIG. 3, in conjunction with FIGS. 1 and 2, carbon footprint estimator 104 includes machine learning engine 301, which builds and trains a first machine learning model based on a sample data set to predict an active energy consumption and an idle energy consumption for the workloads hosted on cloud data center 101 based on the features of the characteristics of the clusters of servers 201 of cloud data center 101 and the features of the characteristics of workloads processed by cloud data center 101. An active energy consumption, as used herein, refers to the energy being consumed (e.g., energy consumed by the data center's computing resources, such as servers, storage, and network) due to the execution of the workload. A workload, as used herein, refers to the tasks, processes, or data transactions to be performed by the cloud data center. An idle energy consumption, as used herein, refers to the energy being consumed by the cloud data center's computing resources (e.g., servers, storage, network) that is independent of the workload and corresponds to the energy required to keep the equipment (e.g., information technology equipment) in active idle state.

As discussed above, the first machine learning model is built and trained based on a sample data set. Such a sample data set includes historical data pertaining to historical server power and resource utilization, historical infrastructure inventory of cloud data center 101, planned additions/upgrades to the infrastructure of cloud data center 101, historical workload data including the service instances (e.g., VMs 204) allocated to servers 201, service level agreement (SLA) specifications, resource allocation and utilization on servers 201 for such services, etc.

Furthermore, in one embodiment, such a sample data set includes historical data corresponding to the features of the characteristics of the clusters of servers 201 of cloud data center 101 and the features of the characteristics of workloads processed by cloud data center 101, such as the utilization of VMs 204 (80% for one core, 50% for two cores, etc.) for a particular workload type (e.g., batch processing, gaming, analytics, etc.), aggregate energy (e.g., kWh) for processing a particular workload type, VM execution times (e.g., hours, minutes, etc.) for processing a particular workload type, etc. Furthermore, such workload types may be classified according to various characteristics of the workload, such as working set sizes (amount of data used or created by a process or workflow in a given time period), usage patterns (categorized as static, periodic, or inconsistent based on their usage patterns), etc.

In one embodiment, such historical data (features of the characteristics of the clusters of servers 201 and the features of the characteristics of workloads) is obtained by monitoring engine 302 of carbon footprint estimator 104, which is configured to monitor servers 201 and the workloads being processed by servers 201 over a user-designated period of time. For example, monitoring engine 302 may utilize various software tools for monitoring the characteristics of the clusters of servers 201 and the workloads being processed by the clusters of servers 201 over a user-designated period of time, including, but not limited to, Dynatrace®, SolarWinds® Network Performance Monitor, Nagios®, Zabbix®, ManageEngine®, etc.

In one embodiment, such historical data is obtained by an expert, such as a developer.

Furthermore, in one embodiment, the sample data set discussed above is referred to herein as the “training data,” which is used by a machine learning algorithm to make predictions or decisions, such as the predicted active energy consumption and idle energy consumption for the workloads hosted on cloud data center 101 based on the features of the characteristics of the clusters of servers 201 and the features of the characteristics of workloads. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

Upon training the first machine learning model, the trained first machine learning model is used to predict active energy consumption and idle energy consumption for the incoming workload to be hosted on cloud data center 101 based on the features of the characteristics of the clusters of servers 201 servicing the incoming workload to be hosted on cloud data center 101 and the features of the characteristics of the incoming workload to be hosted on cloud data center 101 as discussed further below.

In one embodiment, machine learning engine 301 builds and trains a second machine learning model based on a sample data set to predict an active energy consumption and an idle energy consumption for the workloads hosted on cloud data center 101 based on the predicted metrics for the clusters of servers 201 and for the workloads. Predicted metrics, as used herein, refer to metrics, such as power and resource utilization, server and VM allocation, SLA specifications, etc., that are predicted based on time series data. Time series data, as used herein, refers to data that is recorded over consistent intervals of time. For example, such time series data may be generated from aggregated data recorded over consistent intervals of time, such as server resource utilization, energy consumption metrics, workload aggregate size, workload utilization, etc.

In one embodiment, such time series data is acquired by monitoring engine 302 by monitoring servers 201 and workloads being processed by servers 201 over a user-designated period of time. For example, monitoring engine 302 may utilize various software tools for monitoring servers 201 and the workloads being processed by servers 201 over a user-designated period of time, including, but not limited to, Dynatrace®, SolarWinds® Network Performance Monitor, Nagios®, Zabbix®, ManageEngine®, etc.

In one embodiment, the predicted metrics of the clusters of servers 201 and the workloads are generated by machine learning engine 301 based on splitting the time series data into training, validation and testing datasets. Machine learning engine 301 then builds, defines and fits a time series model. Afterwards, the model performance is evaluated and the hyperparameters (parameters whose values control the learning process and determine the values of the model parameters that a learning algorithm ends up learning) are tuned accordingly.

As discussed above, the second machine learning model is built and trained based on a sample data set. Such a sample data set includes historical data pertaining to historical server power and resource utilization, historical infrastructure inventory of cloud data center 101, planned additions/upgrades to the infrastructure of cloud data center 101, historical workload data including the service instances (e.g., VMs 204) allocated to servers 201, service level agreement (SLA) specifications, resource allocation and utilization on servers 201 for such services, etc.

Furthermore, in one embodiment, such a sample data set includes historical data corresponding to predictive metrics, such as power and resource utilization, server and VM allocation, SLA specifications, etc., that are predicted based on time series data. In one embodiment, such time series data is obtained by monitoring engine 302, which is used to generate predictive metrics by machine learning engine 301 as discussed above.

In one embodiment, such historical data is obtained by an expert, such as a developer.

Furthermore, in one embodiment, the sample data set discussed above is referred to herein as the “training data,” which is used by a machine learning algorithm to make predictions or decisions, such as the predicted active energy consumption and idle energy consumption for the workloads hosted on cloud data center 101 based on the predicted metrics for the clusters of servers 201 and for the workloads. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

Upon training the second artificial intelligence model, the trained second artificial intelligence model is used to predict active energy consumption and idle energy consumption for the incoming workload to be hosted on cloud data center 101 based on the predicted metrics for the cluster of servers 201 servicing the incoming workload to be hosted on cloud data center 101 and the predicted metrics for the incoming workload to be hosted on cloud data center 101.

In one embodiment, machine learning engine 301 combines the predicted active energy consumption and idle energy consumption for the incoming workload to be hosted on cloud data center 101 by the trained first and second machine learning models using an ensemble technique. An “ensemble technique,” as used herein, is a machine learning technique that combines multiple models to make predictions more accurate than any single model. Examples of such ensemble techniques include boosting, bagging, and stacking.

Furthermore, in one embodiment, machine learning engine 301 corrects model parameters to the trained first and second machine learning models using reinforcement learning type learning algorithms. Examples of reinforcement learning type learning algorithms include reinforcement random forest (a hybrid of machine learning and regression that learns from its mistakes and improves over time), deep reinforcement learning (uses deep learning methods to model value functions, advantage functions, and parametric policies), policy gradient methods (a class of reinforcement learning algorithms that estimates a gradient for a policy network), etc.

Additionally, carbon footprint estimator 104 includes correlation engine 303, which is configured to perform correlation analysis of servers 201 of cloud data center 101 and the workloads to be hosted on cloud data center 101 based on historical data. Correlation analysis, as used herein, is a statistical method that is used to discover if there is a relationship between two variables/datasets, and how strong that relationship may be.

In one embodiment, correlation engine 303 obtains historical data, upon which correlation analysis is performed, pertaining to servers 201 and the workloads (e.g., types of workloads) to be hosted on cloud data center 101. In one embodiment, such historical data is obtained from a data structure (e.g., table) which stores such historical data, such as configuration, power consumption, resource allocation, utilization, and workload mappings pertaining to servers 201, based on the types of workloads (e.g., transactional, such as online banking, batch processing, such as nightly reports, analytical, such as machine learning, high-performance, such as weather simulations). In one embodiment, such a data structure is populated by monitoring engine 302 by monitoring servers 201 and the workloads being processed by servers 201. For example, monitoring engine 302 may utilize various software tools for monitoring servers 201 and the workloads being processed by servers 201, including, but not limited to, Dynatrace®, SolarWinds® Network Performance Monitor, Nagios®, Zabbix®, ManageEngine®, etc. In one embodiment, such a data structure is populated by an expert, e.g., developer. In one embodiment, such a data structure resides within the storage device of carbon footprint estimator 104.

As discussed above, correlation engine 303 performs correlation analysis based on such historical data. Examples of such correlation analysis include correlation coefficient (statistical analysis that measures the relationship between two variables, including the strength and direction of the relationship), spearman correlation (non-parametric correlation test that measures how associated two variables are), partial correlation (type of correlational analysis that examines the relationship between two variables while also considering the effect of a third variable), etc.

In one embodiment, such correlation analysis is utilized to form clusters of servers 201 of cloud data center 101 to service various types of workloads (e.g., online banking, analytical, etc.) as discussed below.

Carbon footprint estimator 104 further includes clustering engine 304 configured to form clusters of servers 201 of cloud data center 101 based on the correlation analysis of servers 201 of cloud data center 101 and the workloads (types of workloads). In one embodiment, clustering is performed by clustering engine 304 so as to perform selective disaggregation. Such selective disaggregation is utilized so as to focus on the particular servers 201 that are utilized for processing the workload issued by tenant 102. Clustering, as used herein, refers to grouping servers 201 in such a way that such servers 201 are utilized to process a particular incoming workload from tenant 102. A cluster of servers, as used herein, refers to a group of servers 201 working simultaneously, such as under a single IP address, to process a particular incoming workload from tenant 102.

In one embodiment, such a correlation analysis may indicate that a certain cluster of servers (e.g., servers 201A, 201B) are best to be utilized for processing an online banking type of workload. For example, such a correlation analysis may indicate that the cluster of servers 201A, 201N are best to be utilized for processing an analytical type of workload based on power consumption, resource allocation, utilization, and workload mappings. For instance, such correlation analysis may indicate that the cluster of servers 201A, 201N utilize the least amount of power consumption for processing an analytical type of workload thereby indicating a strong correlation between such a cluster of servers 201 and an analytical type of workload.

In one embodiment, clustering engine 304 obtains the characteristics, such as working set size (amount of data used or created by a process or workflow in a given time period), usage pattern (categorized as static, periodic, or inconsistent based on their usage pattern), etc., of the incoming workload to be processed by cloud data center 101 issued by tenant 102.

In one embodiment, clustering engine 304 obtains the characteristics of the incoming workload based on determining the type of workload (e.g., gaming) is the incoming workload. In one embodiment, clustering engine 304 determines the type of workload issued by tenant 102 to be hosted on cloud data center 101 based on the type of application (e.g., artificial intelligence, social media, finance, gaming, video games, etc.) of tenant 102 issuing the workload to be hosted on cloud data center 101. For example, an artificial intelligence application may be deemed to issue an analytical type of workload. In another example, a weather application may be deemed to issue a high-performance type of workload.

In one embodiment, clustering engine 304 performs a search in a data structure (e.g., table) storing the workload characteristics (e.g., working set size, usage pattern, etc.) for various types of workloads. Upon determining the type of workload is the incoming workload, clustering engine 304 performs a search in the data structure for such a type of workload to obtain the workload characteristics associated with such a type of workload. In one embodiment, such workload characteristics for various types of workloads are populated in the data structure by monitoring engine 302 using various monitoring tools, including, but not limited to, Dynatrace®, SolarWinds® Network Performance Monitor, Nagios®, Zabbix®, ManageEngine®, etc. In one embodiment, such a data structure resides within the storage device of carbon footprint estimator 104.

In one embodiment, clustering engine 304 determines which cluster of servers 201 is to be utilized to process the incoming workload to be hosted on cloud data center 101 based on the obtained characteristics of the incoming workload. For example, in one embodiment, upon identifying the type of incoming workload to be hosted on cloud data center 101, clustering engine 304 performs a look-up in a data structure containing a listing of clusters of servers 201 recommended to process particular workloads based on their characteristics. Upon matching the obtained characteristics of the incoming workload in such a data structure, the appropriate cluster of servers 201 to service such a workload is identified from the data structure. In one embodiment, such a data structure is populated by an expert, e.g., developer. In one embodiment, such a data structure is stored in the storage device of carbon footprint estimator 104.

Carbon footprint estimator 104 additionally includes extractor engine 305 configured to extract features of the characteristics of the cluster of servers 201 and the characteristics of the incoming workload. A “feature,” as used herein, is an individual measurable property. Such features may include numerical, categorical features, ordinal features, binary features, etc. Examples of such features include the utilization of VMs 204 (80% for one core, 50% for two cores, etc.) for a particular workload type (e.g., batch processing, gaming, analytics, etc.), aggregate energy (e.g., kWh) for processing a particular workload type, VM execution times (e.g., hours, minutes, etc.) for processing a particular workload type, working set size (amount of data used or created by a process or workflow in a given time period) of the workload, usage pattern (categorized as static, periodic, or inconsistent) of the workload, etc.

In one embodiment, extractor engine 305 extracts features from the characteristics of the cluster of servers 201 and the characteristics of the incoming workload using various feature extraction techniques, such as by using autoencoders. Autoencoders identify key data features by training a neural network to recreate its input thereby discovering and exploiting structures in the data. Through this process, autoencoders reduce dimensionality and extract significant features from the data.

Other feature extraction techniques utilized by extractor engine 305 to extract features from the characteristics of the cluster of servers 201 and the characteristics of the incoming workload include principal component analysis (reduces the dimensionality of the data set while preserving the maximum amount of information), etc.

In one embodiment, the characteristics, upon which features are extracted, are obtained by extractor engine 305 from a data structure (e.g., table), which stores the characteristics (e.g., data volume, transaction rates, read/write ratios, expected growth, latency requirements, application type, peak usage periods, etc.) of various types of workloads, including the incoming workload, and the characteristics (e.g., processing power, reliability, scalability, energy consumption, storage capacity, etc.) of various clusters of servers 201, including the cluster of servers 201 selected to process the incoming workload. For example, upon identifying the cluster of servers 201 to process the incoming workload, extractor engine 205 obtains the characteristics of such a cluster of servers 201 as well as the characteristics of such an incoming workload from the data structure discussed above.

In one embodiment, the data structure containing such characteristics of workloads and the clusters of servers 201 are populated by monitoring engine 302 using various monitoring tools, including, but not limited to, Dynatrace®, SolarWinds® Network Performance Monitor, Nagios®, Zabbix®, ManageEngine®, etc. In one embodiment, such a data structure resides within the storage device of carbon footprint estimator 104.

Carbon footprint estimator 104 further includes predictor engine 306 configured to aggregate resource utilization, energy consumption metrics, workload aggregate size, and workload utilization over time to generate time series data. Time series data, as used herein, refers to data that is recorded over consistent intervals of time. For example, such time series data may be generated from aggregated data recorded over consistent intervals of time, such as server resource utilization, energy consumption metrics, workload aggregate size, workload utilization, etc.

In one embodiment, such time series data is acquired by monitoring engine 302 by monitoring servers 201 and workloads being processed by servers 201 over a user-designated period of time. For example, monitoring engine 302 may utilize various software tools for monitoring servers 201 and the workloads being processed by servers 201 over a user-designated period of time, including, but not limited to, Dynatrace®, SolarWinds® Network Performance Monitor, Nagios®, Zabbix®, ManageEngine®, etc.

Furthermore, predictor engine 306 is configured to generate the predicted metrics for the cluster of servers as well as for the incoming workload based on the time series data generated for the cluster of servers as well as for the incoming workload.

As discussed above, predicted metrics, as used herein, refer to metrics, such as power and resource utilization, server and VM allocation, SLA specifications, etc., that are predicted based on time series data.

In one embodiment, the predicted metrics for the clusters of servers 201 and for the workloads are generated by machine learning engine 301 based on splitting the time series data into training, validation and testing datasets. Machine learning engine 301 then builds, defines and fits a time series model. Afterwards, the model performance is evaluated and the hyperparameters (parameters whose values control the learning process and determine the values of the model parameters that a learning algorithm ends up learning) are tuned accordingly.

Hence, in one embodiment, predictor engine 306 generates predicted metrics for the cluster of servers 201 as well as for the incoming workload based on the time series data inputted into the time series model discussed above.

Additionally, predictor engine 306 is configured to predict the active energy consumption and the idle energy consumption for the incoming workload using the trained first machine learning model based on the extracted features of the characteristics of the cluster of servers 201 selected to service the incoming workload and the extracted features of the characteristics of the incoming workload as discussed above.

Furthermore, predictor engine 306 is configured to predict the active energy consumption and the idle energy consumption for the incoming workload using the trained second machine learning model based on the predicted metrics for the cluster of servers 201 selected to service the incoming workload and the predicted metrics for the incoming workload.

In one embodiment, predictor engine 306 combines the predicted active energy consumption and idle energy consumption for the incoming workload to be hosted on cloud data center 101 by the trained first and second machine learning models forming the estimated energy consumption for the workload using an ensemble technique. Examples of such ensemble techniques include boosting, bagging, and stacking.

Upon estimating the energy consumption for the incoming workload, predictor engine 306 estimates the carbon footprint for the workload based on the estimated energy consumption for the incoming workload as well as the power usage effectiveness of the incoming workload and the carbon intensity of the incoming workload. The power usage effectiveness of the workload is a metric that measures how efficient a cloud data center is at using energy in connection with the workload. In one embodiment, predictor engine 306 calculates the power usage effectiveness using historical time series data (measurements or events that are tracked), such as the total amount of energy cloud data center 101 used divided by the amount of energy used by its IT equipment (e.g., servers 201, storage devices 202, switches 203, etc.) involving the processing of a workload of the same type (e.g., gaming) as the incoming workload by the cloud data center 101. In one embodiment, such historical time series data is stored in a data structure (e.g., table), which includes the total amount of energy cloud data center 101 used divided by the amount of energy used by its IT equipment involving the processing of a workload of a particular type. As discussed above, clustering engine 304 determines the type of workload issued by tenant 102 to be hosted on cloud data center 101. Upon acquiring such information from clustering engine 304, predictor engine 306 performs a look-up in the data structure discussed above for such a type of workload thereby being able to obtain appropriate historical time series data pertaining to the total amount of energy cloud data center 101 used and the amount of energy used by its IT equipment involving the processing of a workload of the same type (e.g., gaming). In one embodiment, such a data structure is populated by an expert. In one embodiment, such a data structure resides within the storage device of carbon footprint estimator 104.

The carbon intensity of the workload refers to how many grams of carbon dioxide (CO₂) are released to produce a kilowatt hour (kWh) of electricity. In one embodiment, the carbon intensity of the workload is calculated using historical time series data (measurements or events that are tracked), such as the grams of carbon dioxide (CO₂) released to produce a kilowatt hour (kWh) of electricity involving the processing of the workload by the cloud data center (e.g., cloud data center 101). In one embodiment, such historical time series data is stored in a data structure (e.g., table), which includes the grams of carbon dioxide (CO₂) released to produce a kilowatt hour (kWh) of electricity involving the processing of a workload of a particular type. As discussed above, clustering engine 304 determines the type of workload issued by tenant 102 to be hosted on cloud data center 101. Upon acquiring such information from clustering engine 304, predictor engine 306 performs a look-up in the data structure discussed above for such a type of workload thereby being able to obtain the appropriate historical time series data pertaining to the grams of carbon dioxide (CO₂) released to produce a kilowatt hour (kWh) of electricity involving the processing of a workload of the same type (e.g., batch processing). In one embodiment, such a data structure is populated by an expert. In one embodiment, such a data structure resides within the storage device of carbon footprint estimator 104.

In one embodiment, predictor engine 306 estimates the carbon footprint for the incoming workload based on applying the following formula: E(t)×PUE(t)×C_{I}(t), where E corresponds to the estimated energy consumption for the incoming workload, PUE corresponds to the power usage effectiveness for the incoming workload and C_{I} corresponds to the carbon intensity for the incoming workload.

In this manner, carbon emissions attributable to workloads to be deployed to a data center (e.g., cloud data center) prior to deployment may be estimated thereby enabling entities to make informed decisions regarding hosting the workload. For example, the entity may decide to have the workload hosted by a particular cloud data center which produces a lesser amount of carbon emissions from processing such a workload versus another cloud data center thereby improving energy efficiency for processing workloads.

A further description of these and other features is provided below in connection with the discussion of the method for estimating a carbon footprint of an incoming workload to be hosted on a cloud data center.

Prior to the discussion of the method for estimating a carbon footprint of an incoming workload to be hosted on a cloud data center, a description of the hardware configuration of carbon footprint estimator 104 (FIG. 1) is provided below in connection with FIG. 4.

Referring now to FIG. 4, in conjunction with FIG. 1, FIG. 4 illustrates an embodiment of the present disclosure of the hardware configuration of carbon footprint estimator 104 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code which is stored in block 401 involved in performing the disclosed methods, such as estimating a carbon footprint of an incoming workload to be hosted on a cloud data center. In addition to block 401, computing environment 400 includes, for example, carbon footprint estimator 104, network 103, such as a wide area network (WAN), end user device (EUD) 402, remote server 403, public cloud 404, and private cloud 405. In this embodiment, carbon footprint estimator 104 includes processor set 406 (including processing circuitry 407 and cache 408), communication fabric 409, volatile memory 410, persistent storage 411 (including operating system 412 and block 401, as identified above), peripheral device set 413 (including user interface (UI) device set 414, storage 415, and Internet of Things (IoT) sensor set 416), and network module 417. Remote server 403 includes remote database 418. Public cloud 404 includes gateway 419, cloud orchestration module 420, host physical machine set 421, virtual machine set 422, and container set 423.

Carbon footprint estimator 104 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 418. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically carbon footprint estimator 104, to keep the presentation as simple as possible. Carbon footprint estimator 104 may be located in a cloud, even though it is not shown in a cloud in FIG. 4. On the other hand, carbon footprint estimator 104 is not required to be in a cloud except to any extent as may be affirmatively indicated.

Processor set 406 includes one, or more, computer processors of any type now known or to be developed in the future. Processing circuitry 407 may be distributed over multiple packages, for example, multiple, coordinated integrated circuit chips. Processing circuitry 407 may implement multiple processor threads and/or multiple processor cores. Cache 408 is memory that is located in the processor chip package(s) and is typically used for data or code that should be available for rapid access by the threads or cores running on processor set 406. Cache memories are typically organized into multiple levels depending upon relative proximity to the processing circuitry. Alternatively, some, or all, of the cache for the processor set may be located “off chip.” In some computing environments, processor set 406 may be designed for working with qubits and performing quantum computing.

Computer readable program instructions are typically loaded onto carbon footprint estimator 104 to cause a series of operational steps to be performed by processor set 406 of carbon footprint estimator 104 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 408 and the other storage media discussed below. The program instructions, and associated data, are accessed by processor set 406 to control and direct performance of the disclosed methods. In computing environment 400, at least some of the instructions for performing the disclosed methods may be stored in block 401 in persistent storage 411.

Communication fabric 409 is the signal conduction paths that allow the various components of carbon footprint estimator 104 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 410 is any type of volatile memory now known or to be developed in the future. Examples include dynamic type random access memory (RAM) or static type RAM. Typically, the volatile memory is characterized by random access, but this is not required unless affirmatively indicated. In carbon footprint estimator 104, the volatile memory 410 is located in a single package and is internal to carbon footprint estimator 104, but, alternatively or additionally, the volatile memory may be distributed over multiple packages and/or located externally with respect to carbon footprint estimator 104.

Persistent Storage 411 is any form of non-volatile storage for computers that is now known or to be developed in the future. The non-volatility of this storage means that the stored data is maintained regardless of whether power is being supplied to carbon footprint estimator 104 and/or directly to persistent storage 411. Persistent storage 411 may be a read only memory (ROM), but typically at least a portion of the persistent storage allows writing of data, deletion of data and re-writing of data. Some familiar forms of persistent storage include magnetic disks and solid state storage devices. Operating system 412 may take several forms, such as various known proprietary operating systems or open source Portable Operating System Interface type operating systems that employ a kernel. The code included in block 401 typically includes at least some of the computer code involved in performing the disclosed methods.

Peripheral device set 413 includes the set of peripheral devices of carbon footprint estimator 104. Data communication connections between the peripheral devices and the other components of carbon footprint estimator 104 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 414 may include components such as a display screen, speaker, microphone, wearable devices (such as goggles and smart watches), keyboard, mouse, printer, touchpad, game controllers, and haptic devices. Storage 415 is external storage, such as an external hard drive, or insertable storage, such as an SD card. Storage 415 may be persistent and/or volatile. In some embodiments, storage 415 may take the form of a quantum computing storage device for storing data in the form of qubits. In embodiments where carbon footprint estimator 104 is required to have a large amount of storage (for example, where carbon footprint estimator 104 locally stores and manages a large database) then this storage may be provided by peripheral storage devices designed for storing very large amounts of data, such as a storage area network (SAN) that is shared by multiple, geographically distributed computers. IoT sensor set 416 is made up of sensors that can be used in Internet of Things applications. For example, one sensor may be a thermometer and another sensor may be a motion detector.

Network module 417 is the collection of computer software, hardware, and firmware that allows carbon footprint estimator 104 to communicate with other computers through WAN 103. Network module 417 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 417 are performed on the same physical hardware device. In other embodiments (for example, embodiments that utilize software-defined networking (SDN)), the control functions and the forwarding functions of network module 417 are performed on physically separate devices, such that the control functions manage several different network hardware devices. Computer readable program instructions for performing the disclosed methods can typically be downloaded to carbon footprint estimator 104 from an external computer or external storage device through a network adapter card or network interface included in network module 417.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 402 is any computer system that is used and controlled by an end user (for example, a customer of an enterprise that operates carbon footprint estimator 104), and may take any of the forms discussed above in connection with carbon footprint estimator 104. EUD 402 typically receives helpful and useful data from the operations of carbon footprint estimator 104. For example, in a hypothetical case where carbon footprint estimator 104 is designed to provide a recommendation to an end user, this recommendation would typically be communicated from network module 417 of carbon footprint estimator 104 through WAN 103 to EUD 402. In this way, EUD 402 can display, or otherwise present, the recommendation to an end user. In some embodiments, EUD 402 may be a client device, such as thin client, heavy client, mainframe computer, desktop computer and so on.

Remote server 403 is any computer system that serves at least some data and/or functionality to carbon footprint estimator 104. Remote server 403 may be controlled and used by the same entity that operates carbon footprint estimator 104. Remote server 403 represents the machine(s) that collect and store helpful and useful data for use by other computers, such as carbon footprint estimator 104. For example, in a hypothetical case where carbon footprint estimator 104 is designed and programmed to provide a recommendation based on historical data, then this historical data may be provided to carbon footprint estimator 104 from remote database 418 of remote server 403.

Public cloud 404 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 404 is performed by the computer hardware and/or software of cloud orchestration module 420. The computing resources provided by public cloud 404 are typically implemented by virtual computing environments that run on various computers making up the computers of host physical machine set 421, which is the universe of physical computers in and/or available to public cloud 404. The virtual computing environments (VCEs) typically take the form of virtual machines from virtual machine set 422 and/or containers from container set 423. It is understood that these VCEs may be stored as images and may be transferred among and between the various physical machine hosts, either as images or after instantiation of the VCE. Cloud orchestration module 420 manages the transfer and storage of images, deploys new instantiations of VCEs and manages active instantiations of VCE deployments. Gateway 419 is the collection of computer software, hardware, and firmware that allows public cloud 404 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 405 is similar to public cloud 404, except that the computing resources are only available for use by a single enterprise. While private cloud 405 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 404 and private cloud 405 are both part of a larger hybrid cloud.

Block 401 further includes the software components discussed above in connection with FIG. 3 to estimate a carbon footprint of an incoming workload to be hosted on a cloud data center. In one embodiment, such components may be implemented in hardware. The functions discussed above performed by such components are not generic computer functions. As a result, carbon footprint estimator 104 is a particular machine that is the result of implementing specific, non-generic computer functions.

In one embodiment, the functionality of such software components of carbon footprint estimator 104, including the functionality for estimating a carbon footprint of an incoming workload to be hosted on a cloud data center, may be embodied in an application specific integrated circuit.

As stated above, currently, data centers, including cloud data centers, consume 1-2% of the total worldwide generated electricity. It is projected that such data centers will consume 8-20% of the total worldwide generated electricity by 2030 due to rapidly increasing application demand, emerging high-energy artificial intelligence workloads, and the flattening of data center power usage effectiveness. In recent years, there has been an increased attention on climate change, which refers to long-terms shifts in temperatures and weather patterns. As a result, there has been a desire to reduce carbon emissions which may be one of the causes of climate change, such as carbon emissions from processing workloads by a cloud data center. That is, there has been a desire to reduce the carbon footprint from processing workloads. A “carbon footprint” refers to the total amount of greenhouse gases, primarily carbon dioxide, emitted by an organization or activity, essentially measuring the contribution to climate change caused by that entity. By reducing one's carbon footprint, the effects of climate change are hoped to be mitigated. Consequently, there is a need to quantify the amount of carbon emissions that result from processing workloads, such as at a cloud data center. Currently, efforts in quantifying the amount of carbon emissions have been focused on workloads that have already been deployed and running on the cloud data center. However, entities may desire to know the amount of carbon emissions that result from a workload to be deployed to a cloud data center prior to such deployment so that the entities can make an informed decision regarding having the cloud data center host the workload. For example, the entity may decide to have the workload be hosted on-premise or be hosted by a different cloud data center which produces a lesser amount of carbon emissions from processing such a workload thereby improving the efficiency of energy utilized for processing workloads. Unfortunately, there is not currently a means for estimating the carbon emissions attributable to workloads to be deployed to a data center (e.g., cloud data center) prior to deployment.

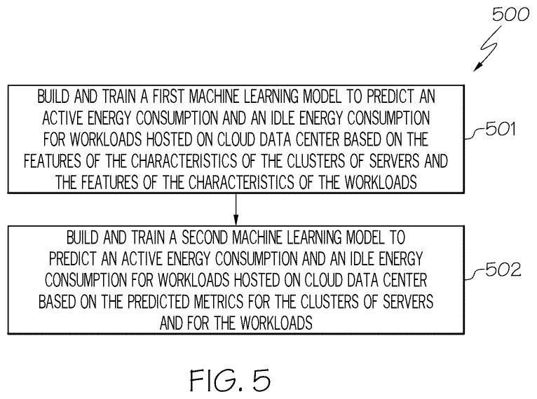

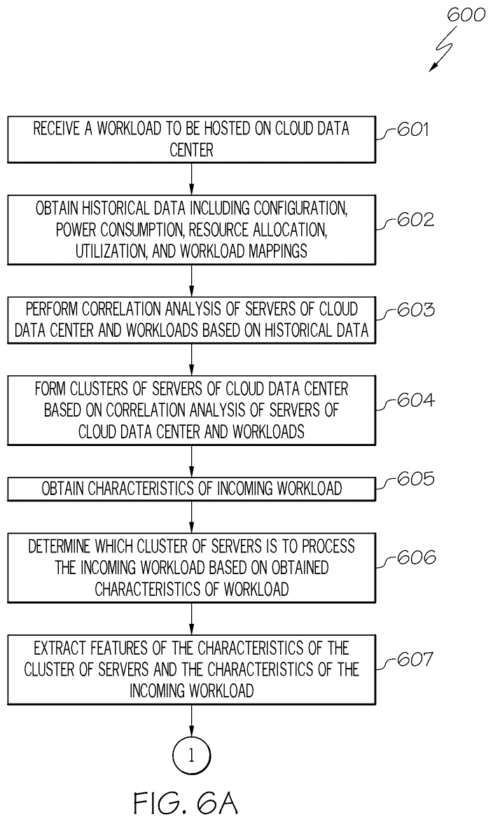

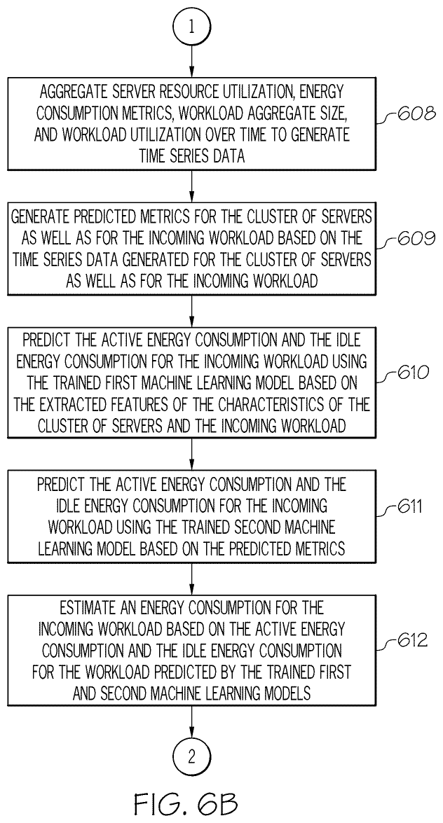

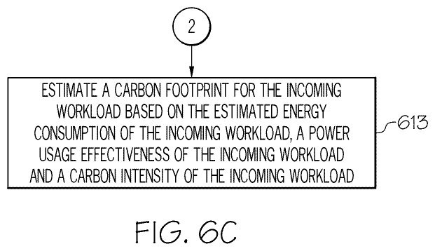

The embodiments of the present disclosure provide a means for estimating a carbon footprint of an incoming workload to be hosted on a cloud data center as discussed below in connection with FIGS. 5 and 6A-6C. FIG. 5 is a flowchart of a method for training machine learning models to predict an active energy consumption and an idle energy consumption for workloads hosted on the cloud data center. FIGS. 6A-6C are a flowchart of a method for estimating a carbon footprint of an incoming workload to be hosted on the cloud data center.

As stated above, FIG. 5 is a flowchart of a method 500 for training machine learning models to predict an active energy consumption and an idle energy consumption for workloads hosted on the cloud data center in accordance with an embodiment of the present disclosure.

Referring to FIG. 5, in conjunction with FIGS. 1-4, in step 501, machine learning engine 301 of carbon footprint estimator 104 builds and trains a first machine learning model based on a sample data set to predict an active energy consumption and an idle energy consumption for the workloads hosted on cloud data center 101 based on the features of the characteristics of the clusters of servers 201 and the features of the characteristics of the workloads.

As discussed above, an active energy consumption, as used herein, refers to the energy being consumed (e.g., energy consumed by the data center's computing resources, such as servers, storage, and network) due to the execution of the workload. A workload, as used herein, refers to the tasks, processes, or data transactions to be performed by the cloud data center. An idle energy consumption, as used herein, refers to the energy being consumed by the cloud data center's computing resources (e.g., servers, storage, network) that is independent of the workload and corresponds to the energy required to keep the equipment (e.g., information technology equipment) in active idle state.

As further discussed above, the first machine learning model is built and trained based on a sample data set. Such a sample data set includes historical data pertaining to historical server power and resource utilization, historical infrastructure inventory of cloud data center 101, planned additions/upgrades to the infrastructure of cloud data center 101, historical workload data including the service instances (e.g., VMs 204) allocated to servers 201, service level agreement (SLA) specifications, resource allocation and utilization on servers 201 for such services, etc.

Furthermore, in one embodiment, such a sample data set includes historical data corresponding to the features of the characteristics of the clusters of servers 201 of cloud data center 101 and the features of the characteristics of workloads processed by cloud data center 101, such as the utilization of VMs 204 (80% for one core, 50% for two cores, etc.) for a particular workload type (e.g., batch processing, gaming, analytics, etc.), aggregate energy (e.g., kWh) for processing a particular workload type, VM execution times (e.g., hours, minutes, etc.) for processing a particular workload type, etc. Furthermore, such workload types may be classified according to various characteristics of the workload, such as working set sizes (amount of data used or created by a process or workflow in a given time period), usage patterns (categorized as static, periodic, or inconsistent based on their usage patterns), etc.

In one embodiment, such historical data (features of the characteristics of the clusters of servers 201 and the features of the characteristics of workloads) is obtained by monitoring engine 302 of carbon footprint estimator 104, which is configured to monitor servers 201 and the workloads being processed by servers 201 over a user-designated period of time. For example, monitoring engine 302 may utilize various software tools for monitoring the characteristics of the clusters of servers 201 and the workloads being processed by the clusters of servers 201 over a user-designated period of time, including, but not limited to, Dynatrace®, SolarWinds® Network Performance Monitor, Nagios®, Zabbix®, ManageEngine®, etc.

In one embodiment, such historical data is obtained by an expert, such as a developer.

Furthermore, in one embodiment, the sample data set discussed above is referred to herein as the “training data,” which is used by a machine learning algorithm to make predictions or decisions, such as the predicted active energy consumption and idle energy consumption for the workloads hosted on cloud data center 101 based on the features of the characteristics of the clusters of servers 201 and the features of the characteristics of workloads. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

Upon training the first machine learning model, the trained first machine learning model is used to predict the active energy consumption and idle energy consumption for the incoming workload to be hosted on cloud data center 101 based on the features of the characteristics of the clusters of servers 201 servicing the incoming workload to be hosted on cloud data center 101 and the features of the characteristics of the incoming workload to be hosted on cloud data center 101 as discussed below in connection with FIGS. 6A-6C.

In step 502, machine learning engine 301 of carbon footprint estimator 104 builds and trains a second machine learning model based on a sample data set to predict an active energy consumption and an idle energy consumption for the workloads hosted on cloud data center 101 based on the predicted metrics for the clusters of servers 201 and for the workloads.

As discussed above, predicted metrics, as used herein, refer to metrics, such as power and resource utilization, server and VM allocation, SLA specifications, etc., that are predicted based on time series data. Time series data, as used herein, refers to data that is recorded over consistent intervals of time. For example, such time series data may be generated from aggregated data recorded over consistent intervals of time, such as server resource utilization, energy consumption metrics, workload aggregate size, workload utilization, etc.

In one embodiment, such time series data is acquired by monitoring engine 302 by monitoring servers 201 and workloads being processed by servers 201 over a user-designated period of time. For example, monitoring engine 302 may utilize various software tools for monitoring servers 201 and the workloads being processed by servers 201 over a user-designated period of time, including, but not limited to, Dynatrace®, SolarWinds® Network Performance Monitor, Nagios®, Zabbix®, ManageEngine®, etc.

In one embodiment, the predicted metrics for the clusters of servers 201 and for the workloads are generated by machine learning engine 301 based on splitting the time series data into training, validation and testing datasets. Machine learning engine 301 then builds, defines and fits a time series model. Afterwards, the model performance is evaluated and the hyperparameters (parameters whose values control the learning process and determine the values of the model parameters that a learning algorithm ends up learning) are tuned accordingly.

As discussed above, the second machine learning model is built and trained based on a sample data set. Such a sample data set includes historical data pertaining to historical server power and resource utilization, historical infrastructure inventory of cloud data center 101, planned additions/upgrades to the infrastructure of cloud data center 101, historical workload data including the service instances (e.g., VMs 204) allocated to servers 201, service level agreement (SLA) specifications, resource allocation and utilization on servers 201 for such services, etc.

Furthermore, in one embodiment, such a sample data set includes historical data corresponding to predictive metrics, such as power and resource utilization, server and VM allocation, SLA specifications, etc., that are predicted based on time series data. In one embodiment, such time series data is obtained by monitoring engine 302, which is used to generate predictive metrics by machine learning engine 301 as discussed above.

In one embodiment, such historical data is obtained by an expert, such as a developer.

Furthermore, in one embodiment, the sample data set discussed above is referred to herein as the “training data,” which is used by a machine learning algorithm to make predictions or decisions, such as the predicted active energy consumption and idle energy consumption for the workloads hosted on cloud data center 101 based on the predicted metrics for the clusters of servers 201 and for the workloads. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

Upon training the second artificial intelligence model, the trained second artificial intelligence model is used to predict active energy consumption and idle energy consumption for the incoming workload to be hosted on cloud data center 101 based on the predicted metrics for the cluster of servers 201 servicing the incoming workload to be hosted on cloud data center 101 and the predicted metrics for the incoming workload to be hosted on cloud data center 101 as discussed below in connection with FIGS. 6A-6C.

FIGS. 6A-6C are a flowchart of a method 600 for estimating a carbon footprint of an incoming workload to be hosted on a cloud data center in accordance with an embodiment of the present disclosure.

Referring to FIG. 6A, in conjunction with FIGS. 1-5, in step 601, carbon footprint estimator 104 receives a workload (e.g., batch workload, analytical workload, transactional workload, etc.) to be hosted on cloud data center 101, such as from tenant 102.

A workload, as used herein, refers to the tasks, processes, or data transactions to be performed by cloud data center 101, such as performed by servers 201 of cloud data center 101.

In step 602, correlation engine 303 of carbon footprint estimator 104 obtains historical data, such as configuration, power consumption, resource allocation, utilization, and workload mappings, pertaining to servers 201 and the workloads (e.g., types of workloads) to be hosted on cloud data center 101.

As stated above, in one embodiment, correlation engine 303 obtains historical data, upon which correlation analysis is performed, pertaining to servers 201 and the workloads (e.g., types of workloads) to be hosted on cloud data center 101. In one embodiment, such historical data is obtained from a data structure (e.g., table) which stores such historical data, such as configuration, power consumption, resource allocation, utilization, and workload mappings pertaining to servers 201, based on the types of workloads (e.g., transactional, such as online banking, batch processing, such as nightly reports, analytical, such as machine learning, high-performance, such as weather simulations). In one embodiment, such a data structure is populated by monitoring engine 302 by monitoring servers 201 and the workloads being processed by servers 201. For example, monitoring engine 302 may utilize various software tools for monitoring servers 201 and the workloads being processed by servers 201, including, but not limited to, Dynatrace®, SolarWinds® Network Performance Monitor, Nagios®, Zabbix®, ManageEngine®, etc. In one embodiment, such a data structure is populated by an expert, e.g., developer. In one embodiment, such a data structure resides within the storage device (e.g., storage device 411, 415) of carbon footprint estimator 104.

In step 603, correlation engine 303 of carbon footprint estimator 104 performs correlation analysis of servers 201 of cloud data center 101 and the workloads to be hosted on cloud data center 101 based on the historical data (received in step 602).

As discussed above, correlation analysis, as used herein, is a statistical method that is used to discover if there is a relationship between two variables/datasets, and how strong that relationship may be. Examples of such correlation analysis include correlation coefficient (statistical analysis that measures the relationship between two variables, including the strength and direction of the relationship), spearman correlation (non-parametric correlation test that measures how associated two variables are), partial correlation (type of correlational analysis that examines the relationship between two variables while also considering the effect of a third variable), etc.

In step 604, clustering engine 304 of carbon footprint estimator 104 forms clusters of servers 201 of cloud data center 101 to service various types of workloads (e.g., online banking, analytical, etc.) based on the correlation analysis of servers 201 of cloud data center 101 and the workloads (types of workloads).

As stated above, in one embodiment, clustering is performed by clustering engine 304 so as to perform selective disaggregation. Such selective disaggregation is utilized so as to focus on the particular servers 201 that are utilized for processing the workload issued by tenant 102. Clustering, as used herein, refers to grouping servers 201 in such a way that such servers 201 are utilized to process a particular incoming workload from tenant 102.

In one embodiment, such a correlation analysis may indicate that a certain cluster of servers (e.g., servers 201A, 201B) are best to be utilized for processing an online banking type of workload. For example, such a correlation analysis may indicate that the cluster of servers 201A, 201N are best to be utilized for processing an analytical type of workload based on power consumption, resource allocation, utilization, and workload mappings. For instance, such correlation analysis may indicate that the cluster of servers 201A, 201N utilize the least amount of power consumption for processing an analytical type of workload thereby indicating a strong correlation between such a cluster of servers 201 and an analytical type of workload.

In step 605, clustering engine 304 of carbon footprint estimator 102 obtains the characteristics, such as working set size (amount of data used or created by a process or workflow in a given time period), usage pattern (categorized as static, periodic, or inconsistent based on their usage pattern), etc., of the incoming workload to be processed by cloud data center 101 issued by tenant 102.

In one embodiment, clustering engine 304 obtains the characteristics of the incoming workload based on determining the type of workload (e.g., gaming) is the incoming workload. In one embodiment, clustering engine 304 determines the type of workload issued by tenant 102 to be hosted on cloud data center 101 based on the type of application (e.g., artificial intelligence, social media, finance, gaming, video games, etc.) of tenant 102 issuing the workload to be hosted on cloud data center 101. For example, an artificial intelligence application may be deemed to issue an analytical type of workload. In another example, a weather application may be deemed to issue a high-performance type of workload.

In one embodiment, clustering engine 304 performs a search in a data structure (e.g., table) storing the workload characteristics (e.g., working set size, usage pattern, etc.) for various types of workloads. Upon determining the type of workload is the incoming workload, clustering engine 304 performs a search in the data structure for such a type of workload to obtain the workload characteristics associated with such a type of workload. In one embodiment, such workload characteristics for various types of workloads are populated in the data structure by monitoring engine 302 using various monitoring tools, including, but not limited to, Dynatrace®, SolarWinds® Network Performance Monitor, Nagios®, Zabbix®, ManageEngine®, etc. In one embodiment, such a data structure resides within the storage device (e.g., storage device 411, 415) of carbon footprint estimator 104.

In step 606, clustering engine 304 of carbon footprint estimator 104 determines which cluster of servers 201 is to be utilized to process the incoming workload to be hosted on cloud data center 101 based on the obtained characteristics of the incoming workload.

As stated above, for example, in one embodiment, upon identifying the type of incoming workload to be hosted on cloud data center 101, clustering engine 304 performs a look-up in a data structure containing a listing of clusters of servers 201 recommended to process particular workloads based on their characteristics. Upon matching the obtained characteristics of the incoming workload in such a data structure, the appropriate cluster of servers 201 to service such a workload is identified from the data structure. In one embodiment, such a data structure is populated by an expert, e.g., developer. In one embodiment, such a data structure is stored in the storage device (e.g., storage device 411, 415) of carbon footprint estimator 104.

In step 607, extractor engine 305 of carbon footprint estimator 104 extracts the features of the characteristics of the cluster of servers 201 and the characteristics of the incoming workload.

As discussed above, a “feature,” as used herein, is an individual measurable property. Such features may include numerical, categorical features, ordinal features, binary features, etc. Examples of such features include the utilization of VMs 204 (80% for one core, 50% for two cores, etc.) for a particular workload type (e.g., batch processing, gaming, analytics, etc.), aggregate energy (e.g., kWh) for processing a particular workload type, VM execution times (e.g., hours, minutes, etc.) for processing a particular workload type, working set size (amount of data used or created by a process or workflow in a given time period) of the workload, usage pattern (categorized as static, periodic, or inconsistent) of the workload, etc.

In one embodiment, extractor engine 305 extracts features from the characteristics of the cluster of servers 201 and the characteristics of the incoming workload using various feature extraction techniques, such as by using autoencoders. Autoencoders identify key data features by training a neural network to recreate its input thereby discovering and exploiting structures in the data. Through this process, autoencoders reduce dimensionality and extract significant features from the data.

Other feature extraction techniques utilized by extractor engine 305 to extract features from the characteristics of the cluster of servers 201 and the characteristics of the incoming workload include principal component analysis (reduces the dimensionality of the data set while preserving the maximum amount of information), etc.

In one embodiment, the characteristics, upon which features are extracted, are obtained by extractor engine 305 from a data structure (e.g., table), which stores the characteristics (e.g., data volume, transaction rates, read/write ratios, expected growth, latency requirements, application type, peak usage periods, etc.) of various types of workloads, including the incoming workload, and the characteristics (e.g., processing power, reliability, scalability, energy consumption, storage capacity, etc.) of various clusters of servers 201, including the cluster of servers 201 selected to process the incoming workload. For example, upon identifying the cluster of servers 201 to process the incoming workload, extractor engine 205 obtains the characteristics of such a cluster of servers 201 as well as the characteristics of such an incoming workload from the data structure discussed above.

In one embodiment, the data structure containing such characteristics of workloads and the clusters of servers 201 are populated by monitoring engine 302 using various monitoring tools, including, but not limited to, Dynatrace®, SolarWinds® Network Performance Monitor, Nagios®, Zabbix®, ManageEngine®, etc. In one embodiment, such a data structure resides within the storage device (e.g., storage device 411, 415) of carbon footprint estimator 104.

Referring now to FIG. 6B, in conjunction with FIGS. 1-5, in step 608, predictor engine 306 of carbon footprint estimator 102 aggregates server resource utilization, energy consumption metrics, workload aggregate size, and workload utilization over time to generate time series data.

As stated above, time series data, as used herein, refers to data that is recorded over consistent intervals of time. For example, such time series data may be generated from aggregated data recorded over consistent intervals of time, such as server resource utilization, energy consumption metrics, workload aggregate size, workload utilization, etc.

In one embodiment, such time series data is acquired by monitoring engine 302 by monitoring servers 201 and workloads being processed by servers 201 over a user-designated period of time. For example, monitoring engine 302 may utilize various software tools for monitoring servers 201 and the workloads being processed by servers 201 over a user-designated period of time, including, but not limited to, Dynatrace®, SolarWinds® Network Performance Monitor, Nagios®, Zabbix®, ManageEngine®, etc.

In step 609, predictor engine 306 of carbon footprint estimator 102 generates predicted metrics for the cluster of servers as well as for the incoming workload based on the time series data generated for the cluster of servers as well as for the incoming workload.

As discussed above, predicted metrics, as used herein, refer to metrics, such as power and resource utilization, server and VM allocation, SLA specifications, etc., that are predicted based on time series data.

In one embodiment, the predicted metrics for the clusters of servers 201 and for the workloads are generated by machine learning engine 301 based on splitting the time series data into training, validation and testing datasets. Machine learning engine 301 then builds, defines and fits a time series model. Afterwards, the model performance is evaluated and the hyperparameters (parameters whose values control the learning process and determine the values of the model parameters that a learning algorithm ends up learning) are tuned accordingly.

Hence, in one embodiment, predictor engine 306 generates predicted metrics for the cluster of servers 201 as well as for the incoming workload based on the time series data inputted into the time series model discussed above.

In step 610, predictor engine 306 of carbon footprint estimator 104 predicts the active energy consumption and the idle energy consumption for the incoming workload using the trained first machine learning model based on the extracted features of the characteristics of the cluster of servers 201 selected to service the incoming workload and the extracted features of the characteristics of the incoming workload as discussed above.

In step 611, predictor engine 306 of carbon footprint estimator 104 predicts the active energy consumption and the idle energy consumption for the incoming workload using the trained second machine learning model based on the predicted metrics for the cluster of servers 201 selected to service the incoming workload and the predicted metrics for the incoming workload.

In step 612, predictor engine 306 of carbon footprint estimator 104 combines the predicted active energy consumption and idle energy consumption for the incoming workload to be hosted on cloud data center 101 by the trained first and second machine learning models forming the estimated energy consumption for the incoming workload using an ensemble technique. Examples of such ensemble techniques include boosting, bagging, and stacking.

Referring now to FIG. 6C, in conjunction with FIGS. 1-5, in step 613, predictor engine 306 of carbon footprint estimator 104 estimates the carbon footprint for the incoming workload based on the estimated energy consumption of the incoming workload as well as the power usage effectiveness of the incoming workload and the carbon intensity of the incoming workload.

As discussed above, the power usage effectiveness of the workload is a metric that measures how efficient a cloud data center is at using energy in connection with the workload. In one embodiment, predictor engine 306 calculates the power usage effectiveness using historical time series data (measurements or events that are tracked), such as the total amount of energy cloud data center 101 used divided by the amount of energy used by its IT equipment (e.g., servers 201, storage devices 202, switches 203, etc.) involving the processing of a workload of the same type (e.g., gaming) as the incoming workload by the cloud data center 101. In one embodiment, such historical time series data is stored in a data structure (e.g., table), which includes the total amount of energy cloud data center 101 used divided by the amount of energy used by its IT equipment involving the processing of a workload of a particular type. As discussed above, clustering engine 304 determines the type of workload issued by tenant 102 to be hosted on cloud data center 101. Upon acquiring such information from clustering engine 304, predictor engine 306 performs a look-up in the data structure discussed above for such a type of workload thereby being able to obtain appropriate historical time series data pertaining to the total amount of energy cloud data center 101 used and the amount of energy used by its IT equipment involving the processing of a workload of the same type (e.g., gaming). In one embodiment, such a data structure is populated by an expert. In one embodiment, such a data structure resides within the storage device (e.g., storage device 411, 415) of carbon footprint estimator 104.

The carbon intensity of the workload refers to how many grams of carbon dioxide (CO₂) are released to produce a kilowatt hour (kWh) of electricity. In one embodiment, the carbon intensity of the workload is calculated using historical time series data (measurements or events that are tracked), such as the grams of carbon dioxide (CO₂) released to produce a kilowatt hour (kWh) of electricity involving the processing of the workload by the cloud data center (e.g., cloud data center 101). In one embodiment, such historical time series data is stored in a data structure (e.g., table), which includes the grams of carbon dioxide (CO₂) released to produce a kilowatt hour (kWh) of electricity involving the processing of a workload of a particular type. As discussed above, clustering engine 304 determines the type of workload issued by tenant 102 to be hosted on cloud data center 101. Upon acquiring such information from clustering engine 304, predictor engine 306 performs a look-up in the data structure discussed above for such a type of workload thereby being able to obtain the appropriate historical time series data pertaining to the grams of carbon dioxide (CO₂) released to produce a kilowatt hour (kWh) of electricity involving the processing of a workload of the same type (e.g., batch processing). In one embodiment, such a data structure is populated by an expert. In one embodiment, such a data structure resides within the storage device (e.g., storage device 411, 415) of carbon footprint estimator 104.

In one embodiment, predictor engine 306 estimates the carbon footprint for the incoming workload based on applying the following formula: E(t)×PUE(t)×C_{I}(t), where E corresponds to the estimated energy consumption for the incoming workload, PUE corresponds to the power usage effectiveness for the incoming workload and C_{I} corresponds to the carbon intensity for the incoming workload.

In this manner, carbon emissions attributable to workloads to be deployed to a data center (e.g., cloud data center) prior to deployment may be estimated thereby enabling entities to make informed decisions regarding hosting the workload. For example, the entity may decide to have the workload hosted by a particular cloud data center which produces a lesser amount of carbon emissions from processing such a workload versus another cloud data center thereby improving energy efficiency for processing workloads.

Furthermore, the principles of the present disclosure improve the technology or technical field involving energy usage of cloud data centers.

As discussed above, currently, data centers, including cloud data centers, consume 1-2% of the total worldwide generated electricity. It is projected that such data centers will consume 8-20% of the total worldwide generated electricity by 2030 due to rapidly increasing application demand, emerging high-energy artificial intelligence workloads, and the flattening of data center power usage effectiveness. In recent years, there has been an increased attention on climate change, which refers to long-terms shifts in temperatures and weather patterns. As a result, there has been a desire to reduce carbon emissions which may be one of the causes of climate change, such as carbon emissions from processing workloads by a cloud data center. That is, there has been a desire to reduce the carbon footprint from processing workloads. A “carbon footprint” refers to the total amount of greenhouse gases, primarily carbon dioxide, emitted by an organization or activity, essentially measuring the contribution to climate change caused by that entity. By reducing one's carbon footprint, the effects of climate change are hoped to be mitigated. Consequently, there is a need to quantify the amount of carbon emissions that result from processing workloads, such as at a cloud data center. Currently, efforts in quantifying the amount of carbon emissions have been focused on workloads that have already been deployed and running on the cloud data center. However, entities may desire to know the amount of carbon emissions that result from a workload to be deployed to a cloud data center prior to such deployment so that the entities can make an informed decision regarding having the cloud data center host the workload. For example, the entity may decide to have the workload be hosted on-premise or be hosted by a different cloud data center which produces a lesser amount of carbon emissions from processing such a workload thereby improving the efficiency of energy utilized for processing workloads. Unfortunately, there is not currently a means for estimating the carbon emissions attributable to workloads to be deployed to a data center (e.g., cloud data center) prior to deployment.

Embodiments of the present disclosure improve such technology by training a first machine learning model to predict an active energy consumption and an idle energy consumption for workloads hosted on the cloud data center based on the features of the characteristics of the clusters of servers of the cloud data center and the features of the characteristics of the workloads processed by the cloud data center. Furthermore, a second machine learning model is trained to predict an active energy consumption and an idle energy consumption for workloads hosted on the cloud data center based on the predicted metrics for the clusters of servers of the cloud data center and the predicted metrics for the workloads processed by the cloud data center. Upon training such machine learning models, such machine learning models are used in combination to estimate the energy consumption for an incoming workload to be hosted on the cloud data center based on the active energy consumption and the idle energy consumption predicted by the trained first and second machine learning models. Upon estimating the energy consumption for the workload, the carbon footprint for the workload is estimated based on the estimated energy consumption for the workload as well as the power usage effectiveness of the workload and the carbon intensity of the workload. In this manner, carbon emissions attributable to workloads to be deployed to a data center (e.g., cloud data center) prior to deployment may be estimated thereby enabling entities to make informed decisions regarding hosting the workload, including utilizing more energy efficient means for processing the workload. For example, the workload may be hosted by a particular cloud data center which produces a lesser amount of carbon emissions from processing such a workload in comparison to other cloud data centers. Furthermore, in this manner, there is an improvement in the technical field involving energy usage of cloud data centers.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for estimating a carbon footprint of an incoming workload to be hosted on a cloud data center, the method comprising:
training a first machine learning model to predict an active energy consumption and an idle energy consumption for workloads hosted on said cloud data center based on features of characteristics of clusters of servers and features of characteristics of workloads;
training a second machine learning model to predict said active energy consumption and said idle energy consumption for workloads hosted on said cloud data center based on predicted metrics for said clusters of servers and for said workloads;
receiving a workload to be hosted on said cloud data center;
predicting said active energy consumption and said idle energy consumption for said workload using said first trained machine learning model based on features of said characteristics of said workload and features of said characteristics of a cluster of servers said workload is to be processed;
predicting said active energy consumption and said idle energy consumption for said workload using said trained second machine learning model using predicted metrics for said cluster of servers as well as for said workload;
estimating an energy consumption for said workload based on said active energy consumption and said idle energy consumption for said workload predicted by said trained first machine learning model and said trained second machine learning model; and
estimating a carbon footprint for said workload based on said estimated energy consumption for said workload, a power usage effectiveness of said workload and a carbon intensity of said workload.

2. The method as recited in claim 1 further comprising:
obtaining characteristics of said workload and clusters of servers of said cloud data center; and
determining said cluster of servers said workload is to be processed based on said obtained characteristics of said workload and said clusters of servers of said cloud data center.

3. The method as recited in claim 1 further comprising:
obtaining historical data comprising configuration, power consumption, resource allocation, utilization, and workload mappings; and
performing correlation analysis of servers of said cloud data center and said workloads based on said historical data.

4. The method as recited in claim 3 further comprising:
forming said clusters of servers of said cloud data center based on said correlation analysis of said servers of said cloud data center and said workloads.

5. The method as recited in claim 1 further comprising:
aggregating server resource utilization, energy consumption metrics, workload aggregate size, and workload utilization over time to generate time series data; and
generating said predicted metrics for said cluster of servers as well as for said workload based on said time series data generated for said cluster of servers as well as for said workload.

6. The method as recited in claim 1 further comprising:
extracting features of said characteristics of said cluster of servers and said characteristics of said workload using autoencoders or principal component analysis.

7. The method as recited in claim 1, wherein said energy consumption for said workload is estimated based on an ensemble technique for combining said trained first machine learning model with said trained second machine learning model.

8. A computer program product for estimating a carbon footprint of an incoming workload to be hosted on a cloud data center, the computer program product comprising one or more computer readable storage mediums having program code embodied therewith, the program code comprising programming instructions for:
training a first machine learning model to predict an active energy consumption and an idle energy consumption for workloads hosted on said cloud data center based on features of characteristics of clusters of servers and features of characteristics of workloads;
training a second machine learning model to predict said active energy consumption and said idle energy consumption for workloads hosted on said cloud data center based on predicted metrics for said clusters of servers and for said workloads;
receiving a workload to be hosted on said cloud data center;
predicting said active energy consumption and said idle energy consumption for said workload using said first trained machine learning model based on features of said characteristics of said workload and features of said characteristics of a cluster of servers said workload is to be processed;
predicting said active energy consumption and said idle energy consumption for said workload using said trained second machine learning model using predicted metrics for said cluster of servers as well as for said workload;
estimating an energy consumption for said workload based on said active energy consumption and said idle energy consumption for said workload predicted by said trained first machine learning model and said trained second machine learning model; and
estimating a carbon footprint for said workload based on said estimated energy consumption for said workload, a power usage effectiveness of said workload and a carbon intensity of said workload.

9. The computer program product as recited in claim 8, wherein the program code further comprises the programming instructions for:
obtaining characteristics of said workload and clusters of servers of said cloud data center; and
determining said cluster of servers said workload is to be processed based on said obtained characteristics of said workload and said clusters of servers of said cloud data center.

10. The computer program product as recited in claim 8, wherein the program code further comprises the programming instructions for:
obtaining historical data comprising configuration, power consumption, resource allocation, utilization, and workload mappings; and
performing correlation analysis of servers of said cloud data center and said workloads based on said historical data.

11. The computer program product as recited in claim 10, wherein the program code further comprises the programming instructions for:
forming said clusters of servers of said cloud data center based on said correlation analysis of said servers of said cloud data center and said workloads.

12. The computer program product as recited in claim 8, wherein the program code further comprises the programming instructions for:
aggregating server resource utilization, energy consumption metrics, workload aggregate size, and workload utilization over time to generate time series data; and
generating said predicted metrics for said cluster of servers as well as for said workload based on said time series data generated for said cluster of servers as well as for said workload.

13. The computer program product as recited in claim 8, wherein the program code further comprises the programming instructions for:
extracting features of said characteristics of said cluster of servers and said characteristics of said workload using autoencoders or principal component analysis.

14. The computer program product as recited in claim 8, wherein said energy consumption for said workload is estimated based on an ensemble technique for combining said trained first machine learning model with said trained second machine learning model.

15. A system, comprising:
a memory for storing a computer program for estimating a carbon footprint of an incoming workload to be hosted on a cloud data center; and
a processor connected to the memory, wherein the processor is configured to execute program instructions of the computer program comprising:
training a first machine learning model to predict an active energy consumption and an idle energy consumption for workloads hosted on said cloud data center based on features of characteristics of clusters of servers and features of characteristics of workloads;
training a second machine learning model to predict said active energy consumption and said idle energy consumption for workloads hosted on said cloud data center based on predicted metrics for said clusters of servers and for said workloads;
receiving a workload to be hosted on said cloud data center;
predicting said active energy consumption and said idle energy consumption for said workload using said first trained machine learning model based on features of said characteristics of said workload and features of said characteristics of a cluster of servers said workload is to be processed;
predicting said active energy consumption and said idle energy consumption for said workload using said trained second machine learning model using predicted metrics for said cluster of servers as well as for said workload;
estimating an energy consumption for said workload based on said active energy consumption and said idle energy consumption for said workload predicted by said trained first machine learning model and said trained second machine learning model; and
estimating a carbon footprint for said workload based on said estimated energy consumption for said workload, a power usage effectiveness of said workload and a carbon intensity of said workload.

16. The system as recited in claim 15, wherein the program instructions of the computer program further comprise:
obtaining characteristics of said workload and clusters of servers of said cloud data center; and
determining said cluster of servers said workload is to be processed based on said obtained characteristics of said workload and said clusters of servers of said cloud data center.

17. The system as recited in claim 15, wherein the program instructions of the computer program further comprise:
obtaining historical data comprising configuration, power consumption, resource allocation, utilization, and workload mappings; and
performing correlation analysis of servers of said cloud data center and said workloads based on said historical data.

18. The system as recited in claim 17, wherein the program instructions of the computer program further comprise:
forming said clusters of servers of said cloud data center based on said correlation analysis of said servers of said cloud data center and said workloads.

19. The system as recited in claim 15, wherein the program instructions of the computer program further comprise:
aggregating server resource utilization, energy consumption metrics, workload aggregate size, and workload utilization over time to generate time series data; and
generating said predicted metrics for said cluster of servers as well as for said workload based on said time series data generated for said cluster of servers as well as for said workload.

20. The system as recited in claim 15, wherein the program instructions of the computer program further comprise:
extracting features of said characteristics of said cluster of servers and said characteristics of said workload using autoencoders or principal component analysis.
